(19) United States
(12) Patent Application Publication
(10) Pub. No.: US 2007/0141214 A1
(43) Pub. Date: Jun. 21, 2007

(54) Composition for the surface treatment of foods

(75) Inventors: Klaus Krämer, Landau (DE); Karl Kolter, Limburgerhof (DE); Herbert Dennis Woolf, Easton, PA (US)

Correspondence Address: CONNOLLY BOVE LODGE & HUTZ LLP, P.O. BOX 2207, WILMINGTON, DE, 19899-2207, US

(73) Assignee: BASF Aktiengesellschaft Patents, Trademarks and Licenses, Ludwigshafen (DE)

(21) Appl. No.: 10/582,585

(22) PCT Filed: Dec. 9, 2004
(86) PCT No.: PCT/EP04/13992

§ 371 Date: Jun. 12, 2006

Related U.S. Application Data
(60) Provisional application No. 60/530,409, filed on Dec. 18, 2003.

(30) Foreign Application Priority Data
Dec. 12, 2003 (DE) 103 58 802.7

(51) Int. Cl. A21D 4/00

(52) U.S. Cl. 426/321

(57) ABSTRACT

A process for the surface treatment of foods by applying a polymer film, in which, as film-forming polymer, a polyvinyl alcohol-polyether graft copolymer is applied in the form of an aqueous dispersion to the food.

The invention relates to surface treatment compositions for foods, a corresponding process and the use of special polyvinyl alcohol-polyether-graft copolymers (PVA-PEG-graft copolymers) and mixtures thereof with polyvinyl acetate dispersions having low residual monomer contents (PVAc) for the surface treatment of foods to enhance their quality and appearance, and in particular to increase their shelf life, inter alia by affecting the ripening process, and also to correspondingly coated foods.

The greatest losses of foods, in particular of fresh fruit and vegetables, occur between harvest and consumption. Food coating is a method of keeping fruit and vegetables and processed foods fresh for longer, and also protecting them against chemical and microbial contamination and/or oxidative decay. The intention is also to protect fruit and vegetables from drying out. Contaminated foods, owing to toxic substances and bacterial and viral infections, are responsible for a considerable proportion of morbidity and mortality in the population.

Oxidative changes of foods lead, inter alia, to loss of their organoleptic properties, rancidity of fats and the breakdown of essential nutrients. This adversely affects taste, aroma and color, potentially toxic lipid peroxidation products are formed and vitamins are broken down. Examples of these are the nonenzymic browning of cut fruit (apples, bananas) due to the activation of polyphenoloxidases and the oxidative breakdown of color-forming carotenoids and photooxidative changes of lipids and proteins due to the endogenous vitamin riboflavin (sun-struck flavor).

In addition, mechanical stabilization of the surfaces of foods is desirable for many aspects.

Cracks on the surface of the food not only impair the optical appearance, but likewise are accompanied by risk of the penetration of microorganisms.

Particular problems occur, for example, when eggs are used. Eggs are frequently contaminated on the shell surface by microorganisms, especially salmonellae. When the raw eggs are broken, parts of the shell, and thus also the microorganisms, frequently pass into the liquid egg. Since no heating step follows in the manufacture of a multiplicity of egg-containing dishes, a massive multiplication of the microorganisms can occur. However, just the pure handling of contaminated eggs can spread microbes via the hands. Therefore, frequent handwashing is therefore usually required when handling eggs.

In the case of relatively dry bakery products, for example biscuits, there is in addition the problem of excessive crumb formation during drying.

Considered overall, there is therefore a great need for protecting foods against damaging environmental effects.

Fruit such as apples, pears and bananas is generally stored under controlled atmosphere or modified atmosphere, to increase shelf life. Treating these foods with a surface treatment composition (coating) is an alternative technology to this by which respiration and drying and microbial decay can be decreased and thus the shelf life extended. However, successful coating of fresh fruit and vegetables is dependent on the internal gas composition, since otherwise off-flavors are formed, as discussed by H J Park in a review (H J Park. Development of advanced edible coating for fruits. Trends Food Sci Technol 10: 254-260, 1999).

Waxes were used as early as the 12th and 13th Century as the first edible coating material for fruits.

Numerous other polymers capable of film formation are known as coating compositions for foods. These include, in addition to the waxes, solid fats, carbohydrates and proteins, and resins and synthetic polymers. Examples of carbohydrates are celluloses, such as carboxymethyl cellulose and hydroxypropyl cellulose, starches, pectins, alginates, guar, carrageenan, carob bean meal, chitosan, pullulans and xanthans. Proteins which are currently used are caseinates, whey proteins, keratins, collagens, soybean protein isolates and zein. Waxes comprise beeswax, polycosanols, and carnauba wax. Shellac is the only resin which is suitable for food use. This resin is produced via the proboscis of the female of the scale insect Tachardia lacca being inserted into the twigs of various trees in India and Thailand, inter alia. Via the proboscis, the saps are in part converted to resin. Synthetic polymers are, for example, polyethylene, polypropylene, polyvinyl acetate (PVAc), polyvinyl alcohol (PVA) or polyacrylates.

U.S. Pat. No. 6,6165,529 discloses the use of aqueous coating compositions which comprise cold-water-insoluble, completely saponified polyvinyl alcohol, starch and a surfactant. However, the cold-water insolubility of the polyvinyl alcohol has various application disadvantages.

The use of a 15-35% strength PVAc emulsion for coating bananas is described in U.S. Pat. No. 3,262,785 for delaying ripening. Prolongation of the post-harvest shelf life of perishable fruit and vegetables using at least 50% by weight PVAc, so that the coating material is 0.5-1.5% of the weight of the fruit or vegetables is disclosed by U.S. Pat. No. 3,410,696.

CS 122635 describes an emulsion of PVAc and polyvinyl alcohol for coating foods, for example cheese. The use of PVAc containing phthalates as plasticizer for the coating of fruit and vegetables is described in FR 1453484. However, phthalates are unsuitable as food-contact material in view of their toxicological profile and their migration properties. WO 00/18375 discloses the use of PVA-polyether-graft copolymers as binders or film-forming aids for pharmaceutical dosage forms.

DE 1236310 discloses an aqueous dispersion of PVAc for coating foods, in particular cheese.

U.S. Pat. No. 6,162,475 discloses the use of alcoholic solutions of PVAc for coating fruits, vegetables and processed foods having a high gloss formation.

However, a disadvantage of coating made of PVAc is the low water solubility of the coatings. Although PVAc is a polymer authorized for food technology, which can also be consumed, however, the PVAc coating, on consumption, can cause an unpleasant mouthfeel.

It is an object of the present invention to find improved coatings for coating foods, which coatings have more favorable application properties and do not lead to an impairment of the organoleptic properties.

We have found that this object is achieved by a process and the use of aqueous dispersions of polyvinyl alcohol-polyether graft copolymers for coating foods.

Foods, for the purposes of the present invention, are, principally, fruit, vegetables, dairy products, sausage and ham products, eggs or bakery products. In particular, the invention relates to treating fruit, such as bananas, apples, pears, mangoes, papayas, avocados, strawberries and the like, and to treating eggs.

A particular embodiment of the invention relates to a mixture of the PVA-PEG graft copolymers with polyvinyl acetate (PVAc) in different mixing ratios, in order to adapt the barrier properties and mechanical properties of the film coating to the requirement of the respective application.

The polyvinyl alcohol-polyether graft copolymers used according to the invention are known per se, just as is their use in pharmaceutical or cosmetic dosage forms. Their production is described in general, for example, in WO 02/26845 and EP-A 1125954.

For production, vinyl acetate is polymerized in the presence of a polyether graft base and then the ester groups are saponified in a manner known per se, for example by adding bases. The degree of saponification of the ester groups in the polyvinyl alcohol part is from 80 to 100%, preferably from 90 to 100%.

Graft copolymers are particularly suitable which have a high molecular weight. Thus the PVA-polyether graft copolymer should have a mean molecular weight greater than 25 000 dalton and up to 150 000 dalton, preferably from 35 000 to 100 000 dalton, particularly preferably from 40 000 to 60 000 dalton.

Preference is given to use of graft copolymers which have, as grafting base, a polyethylene glycol or polypropylene glycol having a mean molecular weight of from 400 to 50 000, preferably from 1 000 to 20 000, particularly preferably from 3 000 to 10 000.

Alkyl polyethylene glycols or alkyl polypropylene glycols are also suitable, where alkyl can mean, for example, methyl, ethyl, propyl, butyl, octyl, dodecyl, octadecyl.

Grafting bases which are also suitable are polyoxyethylene-polyoxypropylene block copolymers of the A-B or A-B-A type, where A is the polyoxyethylene part and B is the polyoxypropylene part. The ratio A:B is preferably from 90:10 to 30:70, and the ratio A:B:A is from 45:10:45 to 15:70:15.

The ratio of the polyether used as grafting base to polyvinyl alcohol is from 1:0.5 to 1:50, preferably from 1:1.5 to 1:35, particularly preferably from 1:2 to 1:30.

The PVAc conjointly used in the form of an aqueous dispersion, according to a particular embodiment, should preferably have a mean molecular weight of greater than 200 000 dalton and up to 1 000 000 dalton, preferably from 300 000 to 700 000 dalton.

The preparation of aqueous PVAc dispersions is known per se. The preparation of preferred PVAc dispersions is described, for example, in WO 02/26845.

The aqueous PVAc dispersion can be stabilized by polymeric protecting colloids. A suitable protecting colloid is preferably polyvinylpyrrolidone (PVP), particularly preferably PVP K20 to K40, in particular K30, where the protecting colloid is used in an amount of from 5 to 20% by weight, based on the amount of the vinyl acetate monomer. However, in addition, alkylated, hydroxyalkylated or carboxyalkylated celluloses or starches, for example hydroxypropyl cellulose, methyl cellulose, carboxymethyl starch, and also polyvinyl alcohols and vinylpyrrolidone-vinyl acetate copolymers can also be used as protecting colloids.

In addition, ionic emulsifiers can also be present in the PVAc dispersions in amounts of from 0.2 to 5% by weight, based on the amount of the vinyl acetate monomer. Suitable emulsifiers are, for example, alkali metal salts or ammonium salts of C8-C16-alkyl sulfates, C8-C16-alkylsulfonic acids, of sulfuric acid half ester of ethoxylated alkanols (degree of ethoxylation: from 4 to 100, alkyl: C12-C16), of ethoxylated alkylphenols (EO degree from 3 to 50, alkyl: from C4 to C12) or of C₉-C₁₈-alkylarylsulfonic acids. In addition, alkali metal salts or ammonium salts of fatty acids or lecithin can also be used.

Preference is given to use of sodium lauryl sulfate as emulsifier.

As PVAc, according to the invention a product is suitable, in particular, which has a particularly low residual monomer content of at most 100 ppm. Preference is further given to a mean particle size of the polymer particles of from 50 to <200 nm, particular preference to from 80 to 180 nm, the particle size being determined by light scattering.

A very particularly preferred PVAc quality grade is commercially available as Kollicoate® SR 30D, from BASF Aktiengesellschaft Ludwigshafen.

The aqueous dispersions used according to the invention for coating foods, where the term “dispersion” according to the invention also comprises “aqueous solutions”, can, as mentioned above, as film-forming polymer, comprise pure PVA-polyether graft copolymer, or else possible mixtures of the graft copolymer with PVAC. The aqueous dispersions can therefore have the following compositions, the figures in % by weight relating to the dry weight, and the sum of a), b) and c) being equal to 100% by weight:

a) from 5 to 100% by weight of a polyvinyl alcohol-polyether graft copolymer,

b) from 0 to 95% by weight of polyvinyl acetate, and

c) from 0 to 40% by weight of aids

Preferred mixtures of the two film-forming polymers are those in which the aqueous dispersion has the following composition:

a) from 5 to 95% by weight of a polyvinyl alcohol-polyether graft copolymer,

b) from 5 to 95% by weight of polyvinyl acetate, and

c) from 0 to 40% by weight of aids.

Particularly preferred mixtures are composed as follows:

a) from 10 to 90% by weight of a polyvinyl alcohol-polyether graft copolymer,

b) from 10 to 90% by weight of polyvinyl acetate, and

c) from 0 to 40% by weight of aids.

Very particularly preferred mixtures comprise:

a) from 15 to 85% by weight of a polyvinyl alcohol-polyether graft copolymer,

b) from 15 to 85% by weight of polyvinyl acetate, and

c) from 0 to 40% by weight of aids.

The surface-treatment compositions in the form of aqueous dispersions of aqueous solutions generally have a solids content of from 5 to 50% by weight, preferably from 10 to 40% by weight.

To produce the compositions, procedures can be followed in various ways: the PVA-PEG graft copolymer can be used as powder which is redissolved by stirring with water at room temperature. When a graft copolymer which is only partially water-soluble is used, a dispersion is formed here.

However, it is also possible to use directly the aqueous solution or dispersion produced in the polymerization. Provided that this is not itself microbially inhibitory, a preservative is added to it to prevent microbial contamination during storage.

The PVAc is preferably used in the form of aqueous dispersions having a solids content of from 10 to 50% by weight, preferably from 20 to 40% by weight.

The aqueous surface-treatment compositions, in addition to the film-forming polymers, can comprise further aids, for example functional constituents such as antimicrobial substances to improve food safety, preservatives, antioxidants (ascorbic acid and salts thereof, isoascorbic acid and salts thereof, ascorbyl palmitate and ascorbyl stearate, butylated hydroxytoluene, butylated hydroxyanisole, ethoxyquin, nordihydroguaiaretic acid and salts thereof, isopropyl citrate, gallic acid esters, tocopherols, compounds having an SH structure, for example cysteine, N-acetylcysteine, sulfites, antioxidant extracts, for example rosemary extract) to prevent lipid peroxidation and non-enzymic browning, and also colorants, aroma substances, vitamins, minerals, enzymes, spices and UV-absorbers to improve the organoleptic properties of the food in question. The aids can be used in amounts of from 0 to 40% by weight, preferably from 1 to 30% by weight, based on the dry weight of the surface-treatment composition.

Preservatives which can be used are the following classes of substances, the amounts stated relating to the dry weight of the surface-treatment composition.

Antibiotics, for example natamycin, erythromycin: from 0.0005 to 1.0% by weight, preferably from 0.001 to 0.5% by weight

Acids: from 0.01 to 3% by weight, preferably from 0.05 to 1% by weight, suitable acids are, for example, benzoic acid, sorbic acid, formic acid, propionic acid, undecylenic acid, salicylic acid, peracetic acid, sulfurous acid/sulfur dioxide

Parahydroxybenzoic acid esters: from 0.01 to 3% by weight, preferably from 0.05 to 1% by weight.

Suitable esters are, for example, propyl parahydroxybenzoate,

methyl parahydroxybenzoate,

ethyl parahydroxybenzoate,

butyl parahydroxybenzoate,

benzyl parahydroxybenzoate

alcohols: from 0.05 to 10% by weight, preferably from 0.2 to 2% by weight, for example chlorobutanol, benzyl alcohol, phenylethanol, propylene glycol, menthol

phenols: from 0.01 to 3% by weight, preferably from 0.05 to 1% by weight, for example chlorophenol, p-chloro-m-cresol, thymol, 4-chlorothymol, o-phenylphenol, 8-hydroxyquinoline, eugenol, hydroquinone

aldehydes: in particular formaldehyde and acetaldehyde, from 0.01 to 3% by weight, preferably from 0.05 to 1% by weight.

imidazolidineurea derivatives: from 0.01 to 3% by weight, preferably from 0.05 to 1% by weight

isothiazolines: from 0.01 to 3% by weight, preferably from 0.05 to 1% by weight

quaternary compounds: from 0.001 to 2% by weight, preferably from 0.05 to 1% by weight, for example benzalkonium chloride, cetylpyridinium chloride

benzimidazoles: from 0.01 to 3% by weight, preferably from 0.05 to 1% by weight, for example 2-(4-thiazolyl)benzimidazole

metal ions/metals: from 0.00001 to 0.5% by weight, preferably from 0.0001 to 0.05% by weight, for example silver, copper, zinc

PVP-iodine: from 0.01 to 3% by weight, preferably from 0.05 to 1% by weight

peroxides: from 0.01 to 5% by weight, preferably from 0.05 to 1% by weight, for example hydrogen peroxide, benzoyl peroxide,

biphenyl: from 0.001 to 2% by weight, preferably from 0.01 to 1% by weight

In addition, the surface-treatment compositions can also comprise plasticizers in amounts of from 0.1 to 10% by weight, preferably from 0.5 to 7.5% by weight, based on the dry weight of the coating. Suitable plasticizers are, for example, triacetin, triethyl citrate, polyethylene glycols having molecular weights of from 400 to 10 000, propylene glycol, glycerol, diethyl sebacate, dibutyl sebacate, glycerol monostearate.

The inventive coatings can be applied by various processes, for example dipping, spraying or knife-coating the aqueous dispersion, in which case the drying can be performed simultaneously or subsequently. The drying can be performed by feeding warm air, by microwave radiation or by infrared radiation. The entire coating process can be designed to be batchwise or continuous.

Alternatively, a film can be produced from the polymer, which film, by shrinkage, lies tightly against the food. Such a procedure is suitable, in particular, for sausage and ham products.

The layer thicknesses of the coating, depending on the food and function of the coating, can be from 0.2 to 200 μm, preferably from 1 to 75 μm. The film thickness may be controlled in this case via the amount applied.

Food coated with films according to the invention can, for sterilization without further pretreatment, be irradiated or exposed to a controlled atmosphere. In addition, the foods can be thermally pretreated.

The inventive surface-treatment compositions also permit specific control of the gas and water vapor permeation with the assistance of the films formed. PVAc is a relatively lipophilic polymer and therefore has a relatively high permeability for oxygen and a low permeability for water vapor. PVA-PEG is, in contrast, very hydrophilic and thus more permeable for water vapor and less permeable for oxygen. The permeability for carbon dioxide, ethene, nitrogen and other gases and mediators can also be specifically set by choice of the ratio of the two polymers. In this manner, for example, in the case of fruit products where the ripening is influenced via the ethene concentration, a surface-treatment composition especially matched to the lipophilic ethene can be chosen.

The targeted control of the water-vapor permeation also means that the foods suffer less loss of weight due to drying.

The permeability of films of various compositions was determined in accordance with ASTM F1249 (water vapor) and ASTM D3985(81). The results are listed in table 1.

TABLE 1
Permeability

| | | Water-vapor permeability |
|---|---|---|
| | Oxygen permeability | (g × 100 μm/ |
| | (cm³ × 100 μm/ | m² × d) |
| | m² × d × bar) | at 23° C./ |
| | at 23° C./ | 85% relative humidity |
| | 55% relative humidity | to 0% relative humidity |
| PVA-PEG | 83 | 450 |
| PVA-PEG/PVAc 8:2 | 134 | 517 |
| PVA-PEG/PVAc 6:4 | 155 | 394 |
| PVA-PEG/PVAc 4:6 | 166 | 357 |
| PVA-PEG/PVAc 2:8 | 184 | 231 |
| PVAc | 236 | 164 |

The PVA-PEG used was: Kollicoat® IR, 25% by weight aqueous solution of a graft copolymer of polyethylene glycol 6 000/polyvinyl alcohol (PEG:PVA=25:75), MW: 45 000 dalton

The PVAc used was: Kollicoat SR 30D, aqueous PVAC dispersion containing 30% by weight of solids, containing 27% by weight of PVAc (MW: 450 000 dalton), 2.7% by weight of polyvinylpyrrolidone K30, 0.3% by weight sodium lauryl sulfate; particle size from 150 to 160 nm

By targeted choice of the ratio of the two polymers, in addition to the barrier properties, the solubility properties of the films can be set specifically. If the PVA-PEG graft copolymer predominates in the mixture, or if it is used alone, a coating is obtained which dissolves in water, or which disintegrates. Thus, for example apples which have been coated in this manner can be freed from the coating by simple washing. In contrast, if the PVAc polymer predominates, a water-resistant film is obtained which can be consumed in conjunction.

The particular advantage of the polymers used is also the fact that they have high flexibility and generally do not require plasticizers. Sufficient flexibility is absolutely required for the surface treatment of foods, since otherwise, owing to the ready deformability of many foods, cracks result, which in addition to their unattractive appearance, also greatly impair the protection of the food. Surprisingly, the combination of PVA-PEG graft copolymer with PVAc exhibits a particular synergy, since the elongation at break greatly exceeds the values of the individual components.

This was determined by flexibility measurements on films which were obtained from different mixtures. The results are listed in table 2.

The determination was made in accordance with DIN 53504 at 23° C./53% relative humidity using a Texture Analyzer TA-XT2 HiR from Stable Micro Systems.

TABLE 2
Flexibility measurements

| | Elongation | Tensile strength at break |
|---|---|---|
| | at break (%) | (N/mm²) |
| PVA-PEG | 75 | 14 |
| PVA-PEG/PVAc 8:2 | 94 | 16 |
| PVA-PEG/PVAc 6:4 | 112 | 21 |
| PVA-PEG/PVAc 4:6 | 36 | 25 |
| PVA-PEG/PVAc 2:8 | 12 | 29 |
| PVAc | 3 | 44 |

PVA-PEG: Kollicoat IR
PVAc: Kollicoat SR 30 D

If the flexibility of the films is nevertheless insufficient, a small amount of plasticizer is sufficient to increase the flexibility greatly. Thus, in the case of pure PVAc (Kollicoat SR 30D), by adding 10% propylene glycol, an elongation at break of 300% is achieved, and by adding 5% triacetin, one of 188% is achieved. In the case of the combinations of PVA-PEG graft copolymer and PVAc, the corresponding values with plasticizer are significantly greater than 300%. For example, a film of PVAc:PVA-PEG graft copolymer 8:2 containing 10% propylene glycol has an elongation at break of 370%.

As has been proved, microorganisms are also not able to penetrate the inventive films, which considerably delays the microbial decay of foods. The tightness of the inventive films was tested on the basis of DIN 58953, in which case microbes were applied to one side of the film and any microbes which diffused through were detected on the other side.

In the case of many foods, appearance plays a very important part. For instance, in particular gloss is frequently inadequate and needs to be improved. As a result of the extremely good film-forming and very low roughness of the inventive films, these have a very high gloss which, in addition, is virtually unchanged by the environmental conditions, such as temperature and relative humidity.

Coatings for foods are not to impair the flavor, and by stabilizing the food are to contribute to the flavor being retained after storage. It is therefore quite decisive that the coatings have only low amounts of low-molecular-weight constituents, for example monomers, plasticizers, surfactants, stabilizers, since these can migrate into the food and cause changes. The inventive coatings, precisely in this respect, compared with the prior art, have a very low concentration of these substances and are therefore highly suitable for this application.

In addition, the inventively obtained coatings also have the advantage that they have an improved washability, compared with pure polyvinyl acetate or polyvinyl alcohol coatings, in cases where ability to be washed off the food is desirable.

The inventively used compositions also have the advantage that the use of alcohol can be dispensed with completely and procedures can be carried out in a purely aqueous environment, which achieves considerable advantages with respect to safety, environmental protection and costs.

A further user advantage is the good cold-water-solubility of the PVA-PEG graft copolymer.

Furthermore, the PVAc preferably used in the mixture gives the surface-treatment composition particular advantages, owing to its very low monomer content of <100 ppm, with simultaneously high film-forming and film properties. The small particle size of the dispersion droplets (<200 nm) is responsible, in particular, for this. As a result, an extremely homogeneous film forms, even in the mixture with the graft copolymer.

Production Examples of PVA-PEG Graft Copolymers

### EXAMPLE A (POLYMER A)

72 g of polyethylene glycol (mean molecular weight 6 000) were charged in a polymerization vessel and were heated to 80° C. with stirring and under a gentle nitrogen current. With stirring, and maintaining 80° C., a feed of 410 g of vinyl acetate was added dropwise in 3 h, and at the same time a further feed of a solution of 1.4 g of tert-butyl perpivalate in 30 g of methanol was likewise added dropwise in 3 h. After addition was complete, the mixture was stirred for a further 2 h at 80° C. After cooling, the polymer was dissolved in 450 ml of methanol. For the saponification, 50 ml of a 10% strength methanolic sodium hydroxide solution were added at 30° C. After 45 min the reaction was terminated by adding 750 ml of 1% acetic acid. To remove the methanol the solution was steam-distilled. After subsequent freeze drying of the clear solution a white powder was obtained. Mean molecular weight 45 000 dalton, degree of saponification 94%.

In a similar manner, the following graft copolymers were produced:

Copolymer B containing polyethylene glycol 1000 as grafting base, at a ratio of PEG 1 000 to polyvinyl alcohol of 10:90% by weight and a degree of saponification of 91%.

Copolymer C containing polyethylene glycol 20 000 as grafting base, at a ratio of PEG 20 000 to polyvinyl alcohol of 30:70% by weight and a degree of saponification of 98%.

Copolymer D containing polyethylene glycol 4 000 as grafting base, at a ratio of PEG 4 000 to polyvinyl alcohol of 20:80% by weight and a degree of saponification of 95%.

Copolymer E containing methyl polyethylene glycol 1 500 as grafting base, at a ratio of M-PEG 1 500 to polyvinyl alcohol of 10:90% by weight and a degree of saponification of 91%.

Copolymer F containing octyl polyethylene glycol 4 000 as grafting base, at a ratio of O-PEG 4 000 to polyvinyl alcohol of 25:75% by weight and a degree of saponification of 97%.

Copolymer G containing polyglycerol 1 000 as grafting base, at a ratio of polyglycerol 1 000 to polyvinyl alcohol of 25:75% by weight and a degree of saponification of 95%.

Copolymer H containing polyethylene glycol 1 000 as grafting base, at a ratio of PEG 1 000 to polyvinyl alcohol of 10:90% by weight, and a degree of saponification of 91%.

Copolymer I produced as grafting base containing a polyoxyethylene-polyoxypropylene block copolymer of the A-b-A type, 98:57:98, MW: 12 000, at a ratio of block copolymer to polyvinyl alcohol of 60:40% by weight and a degree of saponification of 83%.

Copolymer K containing a polyoxyethylene-polyoxypropylene block copolymer of the A-B-A type, 79:28:79, MW: 8 500, as grafting base, at a ratio of block copolymer to polyvinyl alcohol of 60:40% by weight and a degree of saponification of 89%.

### USE EXAMPLES

### Example 1

Increasing the Shelf Life of Bananas

Commercially conventional yellow bananas were briefly dipped for 5 seconds into various polymer solutions. After the excess polymer solution had drained off, the bananas were dried in a warm air current at 30° C. until the liquid on the banana skin had solidified to form a uniform film.

The coating compositions used were the following polymer preparations:

PVA-PEG graft copolymer A (according to example A), 5% strength by weight in water

PVA-PEG graft copolymer A, 10% strength by weight in water

Aqueous mixture of PVAc (Kollicoat SR 30 D) and PVA-PEG graft copolymer A, comprising 25% by weight of PVAc, 2.5% by weight of PVA-PEG graft copolymer and 2.5% by weight of propylene glycol, in total 30% by weight solids content in water

The bananas were then stored at 25° C. and approximately 30% relative humidity.

After 7 days the bananas were weighed and rated visually.

All treated bananas, after storage, had a better flavor than the untreated bananas.

| | Loss of weight | Visual ratings |
|---|---|---|
| Start | — | uniform yellow color, less than |
| | | 5% dark blemishes |
| Untreated | 22.6% | more than 75% dark patches, |
| | | scarcely any more yellow color |
| 5% PVA-PEG | 17.8% | from 5 to 15% dark patches, |
| | | predominantly yellow, |
| | | slight gloss |
| 10% PVA-PEG | 16.9% | from 5 to 10% dark patches, |
| | | yellow glossy |
| PVAc/PVA-PEG 10:1 | 13.7% | from 0 to 10% dark patches, |
| | | yellow pronounced gloss |

### Example 2

Improvement of the Gloss of Apples

Commercially conventional apples of the Idared type were dewaxed using a 50% strength ethanol-water mixture, briefly dipped into the solutions mentioned in example 1, taken out, dried in a warm air current and rated visually. The apples were then stored for 11 weeks at 25° C. and 30% relative humidity and again rated. There was no flavor impairment resulting from the treatment.

| | Visual rating after | Visual rating after |
|---|---|---|
| | production | 11 weeks |
| Untreated | matt appearance | matt appearance, slightly |
| | | wrinkled |
| 5% PVA-PEG | slightly glossy | slightly glossy |
| 10% PVA-PEG | strongly glossy | strongly glossy |
| PVAc/PVA-PEG 10:1 | strongly glossy | strongly glossy |

The apples were coated with polymers B to K

### Example 3

Improvement in Shelf Life, Mechanical Strength and the Breaking Behavior of Eggs

Eggs of sales class M were dipped on a sieve into polymer solutions mentioned below, taken out and dried off in a 40° C. warm air current. The eggs were rated visually and weighed. After storage for 4 weeks in a refrigerator at 8° C., the eggs were again examined and the breaking behavior was also tested. In the case of the latter, the eggs were broken on the side of a dish and the number of small fragments was determined.

| | Loss of | | |
|---|---|---|---|
| | weight | Visual rating | Breaking behavior |
| Start | — | Matt | |
| Untreated | 3.24% | Matt | from 3 to 7 small |
| | | | fragments |
| 5% PVA-PEG | 2.17% | slight | from 0 to 1 small |
| | | glossiness | fragments |
| 10% PVA-PEG | 2.08% | attractive | 0 small fragments |
| | | glossiness | |
| PVAc | 1.89% | attractive | from 0 to 1 small |
| | | glossiness | fragments |
| PVAc/PVA-PEG 3:2, | 1.63% | attractive | 0 small fragments |
| 25% solids content | | glossiness | |

### Example 4

Production of Low-Crumb Biscuits

Commercially conventional butter biscuits from Bahlsen of a weight of approximately 5 g were sprayed on the front and back with the polymer solutions/dispersions mentioned in example 1. The spraying nozzle used had an orifice width of 0.5 mm, and the spraying pressure was 1 bar. Directly afterwards, the sprayed biscuits were dried for 8 min at 100° C. in the oven. The amount of polymer applied was in each case approximately 60 mg per biscuit.

After production, the biscuits were rated visually and the weight of the crumbs resulting after cross-wise breakage was determined.

The flavor of the biscuits was not impaired by the application of polymer.

| | | Crumb weight | |
|---|---|---|---|
| | Visual rating after | (mean value from | |
| | production | N = 20) | |
| Untreated | matt appearance | 27 | mg |
| 5% PVA-PEG A | slight glossiness | 16.2 | mg |
| 10% PVA-PEG A | medium glossiness | 8.4 | mg |
| PVAc/PVA-PEG A 10:1 | strong glossiness | 9.4 | mg |

### Example 5

Washability

Untreated apples were given a coating by dipping them in the aqueous polymer solutions below, each of which had a solids content of 5.5% by weight, then the apples were immersed for 30 seconds in water at 21° C. and dried. The amount of polymer coating washed off was determined in % of the application rate.

| | |
|---|---|
| Kollicoat IR | 88.5% |
| Kollicoat IR/Kollicoat SR 30 D | 42.4% |
| 1:9 | |
| Kollicoat SR 30 D | 17.9% |
| For comparison | 26.1% |
| polyvinyl alcohol | |

### Example 6

Microbe Tightness

In this test, which is based on DIN 58953, polymer films of the following composition were tested:

PVA-PEG graft copolymer (75:25)

PVA-PEG graft copolymer (75:25): PVAc 50:50

PVA-PEG graft copolymer (75:25): PVAc 15:85

Circular pieces of diameter 42 mm were cut out of the polymer film under test having a layer thickness of approximately 50 μm.

10 g of quartz powder were mixed with 10 ml of an alcoholic bacterial suspension of Bacillus subtilis of about 1 000 000 CFU/ml and dried for 16 h at 36° C. 20 ml of Caso agar were charged into 250 ml sterile glass laboratory flasks. The sample pieces were fixed between two sealing rings on the rim of the glass laboratory flask. 0.25 g of the loaded quartz powder were distributed uniformly on the sample pieces. The microbial permeation test apparatus was heated to 50° C. Then, it was placed in a refrigerator at 10° C. to cause a suction. This procedure was repeated 5 times.

The microbial permeation test apparatus was then incubated for 24 h at 36° C. No microbial growth was observed in Caso agar for any polymer film, because the microbes could not permeate the film.

1. A process for surface treatment of foods by applying a polymer film, applying to the food, as film-forming polymer, a polyvinyl alcohol-polyether graft copolymer in the form of an aqueous dispersion, wherein the aqueous dispersion, based on the dry content, comprises:
a) from 10 to 90% by weight of a polyvinyl alcohol-polyether graft copolymer,
b) from 10 to 90% by weight of polyvinyl acetate, and
c) from 0 to 50% by weight of aids.

2. A process as claimed in claim 1, wherein the aqueous dispersion, based on the dry content, comprises
a) from 15 to 85% by weight of a polyvinyl alcohol-polyether graft copolymer,
b) from 15 to 85% by weight of polyvinyl acetate, and
c) from 0 to 50% by weight of aids.

3. A process as claimed in claim 2, wherein the aqueous dispersion comprises a polyvinyl acetate having a residual monomer content of less than 100 ppm.

4. An aqueous surface-treatment composition for foods comprising from 10 to 90% by weight, of a polyvinyl alcohol-polyethylene glycol graft copolymer having a mean molecular weight of from 25 000 to 150 000 dalton and from 10 to 90% by weight, of polyvinyl acetate having a mean molecular weight of from 200,000 to 1,000,000 dalton, based on the dry weight of the surface-treatment composition for foods.

5. A surface-treatment composition as claimed in claim 4 comprising a polyvinyl acetate having a mean particle size of from 50 to less than 200 nm.

6. A surface-treatment composition as claimed in claim 4 comprising a polyvinyl acetate having a residual monomer content less than 100 ppm.

7. A food coated with a polymer film, the polymer film consisting of
a) from 10 to 90% by weight of a polyvinyl alcohol-polyether graft copolymer,
b) from 10 to 90% by weight of polyvinyl acetate, and
c) from 0 to 50% by weight of aids.

8. A composition for foods as claimed in claim 4, wherein the composition comprises:
a) from 15 to 85% by weight of a polyvinyl alcohol-polyether graft copolymer,
b) from 15 to 85% by weight of polyvinyl acetate.

9. A surface-treatment composition as claimed in claim 5 comprising a polyvinyl acetate having a residual monomer content of less than 100 ppm.

10. A process as claimed in claim 1 wherein the graft copolymer comprises a weight ratio of polyether to polyvinyl alcohol from 1:2 to 1:30.

11. A surface-treatment composition as claimed in claim 4 wherein the graft copolymer comprises a weight ratio of polyether to polyvinyl alcohol from 1:2 to 1:30.

12. A process as claimed in claim 1 wherein the polyvinyl alcohol has a mean molecular weight from 300,000 to 700,000 dalton.

13. A process as claimed in claim 10 wherein the polyvinyl alcohol has a mean molecular weight from 300,000 to 700,000 dalton.

14. A surface-treatment composition as claimed in claim 11 wherein the polyvinyl alcohol has a mean molecular weight from 300,000 to 700,000 dalton.
